(19) United States
(12) Patent Application Publication
(10) Pub. No.: US 2008/0214779 A1
(43) Pub. Date: Sep. 4, 2008

(54) Polymers with pendant alkyl chains

(76) Inventor: Thomas Daly, Arlington Heights, IL (US)

Correspondence Address: CLIFFORD H. KRAFT, 320 ROBIN HILL DR., NAPERVILLE, IL, 60540, US

(21) Appl. No.: 12/079,924

(22) Filed: Mar. 28, 2008

Related U.S. Application Data
(63) Continuation-in-part of application No. 11/983,377, filed on Nov. 8, 2007.
Application No. 11/983,377 is a continuation-in-part of application No. 10/666,584, filed on Sep. 18, 2003, now abandoned.
(60) Provisional application No. 60/411,907, filed on Sep. 19, 2002.

(51) Int. Cl. C08G 59/02

(52) U.S. Cl. 528/417

(57) ABSTRACT

A hydrophobic polymer made by incorporating alkyl chains pendant to the main backbone of the polymer. Alkyl chains of from about 6 to over 22 carbons are fatty compounds well known in the art. The present invention allows linking such chains from commercially available starting materials. It is well known that starting materials such as tallow diamine or ethoxylated tallow amine typically contain a mixture of chain lengths with varying degrees of branching and unsaturation. The unsaturated positions in the final polymer can be made to cross-link in the presence of a catylst and UV light to increase the hardness and reduce the effect of heat and solvent borne exposures. The present invention can be a replacement to current monomers or additive to common polymers to replace or modify the current polymers to alter the properties of the polymer or economics. The present invention adds the known benefits of fatty compounds to common polymers such as hydrophobicity, or alter the HLB (hydrophilic lipophilic balance) of polymeric surfactants. The present invention is directed primarily to urea, urethane, and urea-urethane linkages, but is expected to be useful in the incorporation of pendant alkyl structures in other types of polymers that use an amine, carboxcylic acid or alcohol group to form the linkage. Other polymer types which can utilize this invention that are obvious to one skilled in the art include, but are not limited to the following: polyamide, polyester, polycarbonate, polyether, polysiloxane, epoxy.

This is a continuation-in-part of co-pending application Ser. No. 11/983,377 filed Nov. 8, 2007 which was a continuation-in-part of application Ser. No. 10/666,584, now abandoned, which claimed priority from U.S. Provisional Patent Application No. 60/411,907 filed Sep. 19, 2002. Applications 60/411,907, Ser. Nos. 10/666,584 and 11/983,377 are hereby incorporated by reference.

The text of the present application is substantially identical to the text of application No. 60/411,907.

### BACKGROUND

1. Field of the Invention

The present invention relates generally to the field of polymers and more particularly to a class of polymers with pendant alkyl chains.

2. Description of The Problem Solved by the Invention

Polymers are very useful compounds that have a wide range of applications. It is known that different monmers allow the customization of properties of the polymer to suit the intended end use. A particular property that is very useful is that of hydrophobicity. A polymer with hydrophobic properties repels water and thus finds great use whenever this property is desired. This type of polymer is particularly useful as a coating, especially if it can be sprayed on.

It is known to use teflon to prevent condensation of large drops of water as demonstrated in U.S. Pat. No. 5,781,291; however, this is expensive, and teflon cannot easily be sprayed on. Other prior art methods of combating water are the use of wax films, ureas and urethanes with various components such as those composed of acrylic or polyester prepolymers. The disadvange is a possible adverse effect on the adhesion to metal substrates if applied in a thick film.

U.S. Pat. No. 3,936,409 describes the synthesis of urea urethanes that can be used to protect various substrates from water, but these polymers do not have substantial hydrophobicity. U.S. Pat. No. 3,936,409 is hereby incorporated by reference.

What is badly needed is a polymer that can be made cheaply and can possibly be sprayed on to form a water repellant coating.

### SUMMARY OF THE INVENTION

The present invention relates to a hydrophobic polymer made by incorporating alkyl chains pendant to the main backbone of the polymer. Alkyl chains of from about 6 to over 22 carbons are fatty compounds well known in the art. The present invention allows linking such chains from commercially available starting materials. It is well known that starting materials such as tallow diamine or ethoxylated tallow amine typically contain a mixture of chain lengths with varying degrees of branching and unsaturation. The unsaturated positions in the final polymer can be made to cross-link in the presence of a catylst and UV light to increase the hardness and reduce the effect of heat and solvent borne exposures.

The present invention can be a replacement to current monomers or additive to common polymers to replace or modify the current polymers to alter the properties of the polymer or economics. The present invention adds the known benefits of fatty compounds to common polymers such as hydrophobicity, or alter the HLB (hydrophilic lipophilic balance) of polymeric surfactants.

The present invention is directed primarily to urea, urethane, and urea-urethane linkages, but is expected to be useful in the incorporation of pendant alkyl structures in other types of polymers that use an amine, carboxcylic acid or alcohol group to form the linkage. Other polymer types which can utilize this invention that are obvious to one skilled in the art include, but are not limited to the following: polyamide, polyester, polycarbonate, polyether, polysiloxane, epoxy.

### DESCRIPTION OF THE FIGURES

FIG. 1 shows urea with a fatty tail pendant to the chain.

FIG. 2 shows urea with a fatty tail pendant to the chain with an either amine.

FIG. 3 shows urethane with a fatty tail pendant to the chain.

FIG. 4 shows urethane with a fatty tail pendant to the chain.

### DETAILED DESCRIPTION OF THE INVENTION

It is well known in the art to combine polyols or polyol pre-polymers with organic isocyanates and other materials to form polymers and polymeric resins. In particular paints and coatings, often contain polyurethane or other polymeric coating materials derived from an amine or alcohol functional monmer. A generic urethane has the following structure:

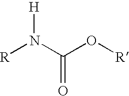

It is well known in the art that R and R′ can be the same or different. A typical polyurethane polymer is made up of chains of the form:

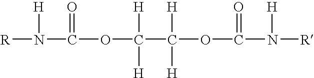

or of the form:

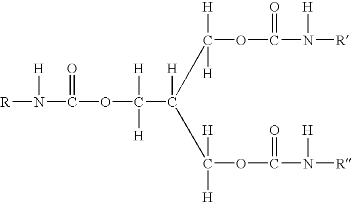

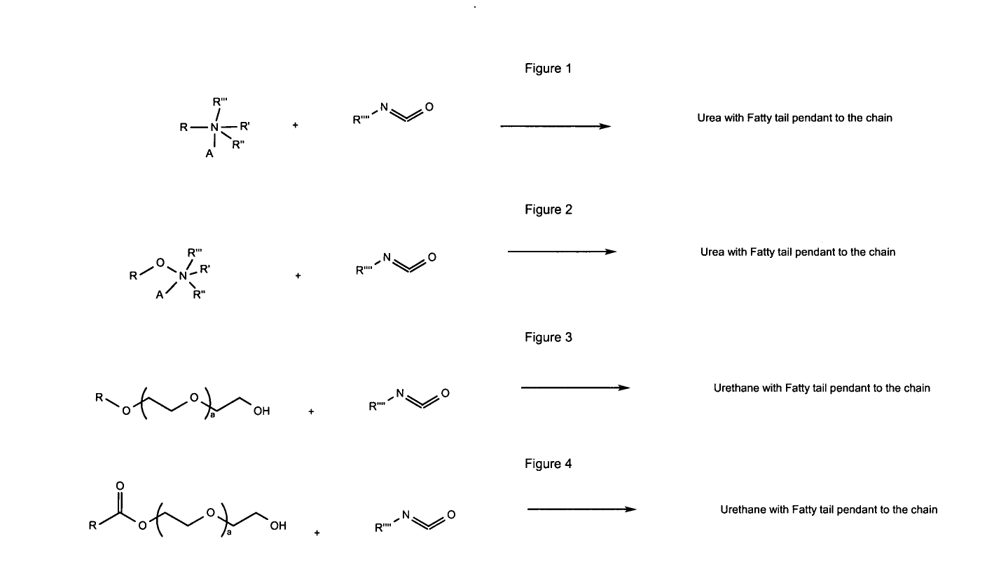

Multifunctional fatty compounds, either polyamines, ethoxylated amines, ethoxylated fatty acids, ethoxylated fatty alcohols, and others can be reacted with isocyantes to form polymers or pre-polymers. to make many polymers that have uses in coatings, structural components and coatings. In particular, ethoxylated fatty acids can be combined with organic isocyanates to form polyurethane type coatings and polymers. This causes the fatty chains to become covalently linked pendant to the backbone of the polymer. Ethoxylated fatty acids and fatty diamines or similar compounds containing multiple isocyanate cross-linkable moieties can be mixed with the polyol component of commercially available two-component systems known in the art. In the case of polyurethane, the linked moiety is similar to that shown in FIG. 1.

FIG. 1. Shows synthesis of a typical polymer of the type described by this invention. R may be any alkyl or alkoxy group of between around 6 to around 22 carbons. R′ and R″ can be a wide range of materials, including, but limited to, H, —(CH2)nNH2, —[(CH2)nNH]m(CH2)o]NH2, with n, m and o from 1 to 30, —(CH2CH2O)a—(CH2CH(CH3)O)b—(CH2CH(CH2CH3)O)cH with a, b, and c integers from 0 to 30, —(CH2)xH with x from 1-30, —(CH2)zCOOH with z from 1 to 20.

R′″ and A are present only in the case that uses of quaternary amines as the starting material. R′″ can not be H, but otherwise conforms to the limits of R′ and R″. A is the anion, which is usually, but not limited to, chlorine.

FIG. 2 Describes the case in which the R is an alkoxy group. FIG. 3 Describes the case in which an ethoxylated alcohol is used as an alky source, and FIG. 4 describes the case in which an ethoxylated carboxcylic acid is used as an alkyl source. R′″—N═C═O is to include all isocyanate containing crosslinking materials.

A typical example of an embodiment of the invention is to combine, for example, an ethoxylated amine with an isocyanate. In this particular case, there are two urethane groups and an amine. This particular class of material provides one fast reacting site and two slower reacting sites. The amine function reacts quickly with the isocyanate while the alcohol is left for later reactions. This causes very linear branches to form with cross linking occuring between the pendant branches after all the amine has reacted. The result is a material that has reacted in a very ordered manner and produced a plastic that has the properties of a highly linear polymer that seems to draw itself out into fibers. By varying the ratio of the reactants, various hardnesses and flexibilities can be achieved. By varying the type of isocyanate used, the speed of cure can be adjusted. By changing the functionality of the alkyl containing component, different properties can be achieved. As Examples 7 and 8 show, these amine free compounds form polymers that are less brittle.

It is an object of the present invention to create a class of hydrophobic urethane, urea, and urea-urethane polymers with alkyl side chains pendant to the main polymer backbone.

It is another object of the present invention to provide a way to control cross-linking in a hydrophobic polymer by controlling the amount of unsaturation present in pendant side chains.

It is still another object of the present invention to provide a method of making low cost sprayable hydrophobic polymer coatings.

The general principle taught by the present invention is primarily directed toward polyurethane, polyurea, and polyurea-urethane structures, but finds use in the incorporation of pendant alkyl structures in other types of polymers that use an amine, carboxcylic acid or alcohol group to form the linkage. Other polymer types which can utilize this invention that are obvious to one skilled in the art include, but are not limited to, the following: polyamide, polyester, polycarbonate, polyether, polysiloxane, epoxy.

The presence of pendant saturated or partially unsaturated fatty chains causes the resulting polymers to have hydrophobic and other desirable properties such as the ability to control the amount of final cross-linking between the pendant chains.

### EXAMPLES

### Example 1

8 g of Tomah E-17-5 (poly (5) oxyethylene isotridecyloxypropylamine) was added to 10 g of Bayer Mondur E744 (pre-poly of diphenylmethane 4,4′-diisocyanate). The resulting tack free solid showed typical polymeric properties as it reacted. During the reaction, a highly fiberous and ordered plastic could be pulled from the vessel. The product liberated heat and foamed during the reaction as well.

### Example 2

6 g of Tomah E-17-2 (poly (2) oxyethylene isotridecyloxypropylamine) was added to 10 g of Bayer Mondur E744 (pre-poly of diphenylmethane 4,4′-diisocyanate). The resulting tack free solid showed typical polymeric properties as it reacted. During the reaction, a highly fiberous and ordered plastic could be pulled from the vessel. The product liberated heat, but foamed less than than Example 1. In a repeat of the reaction, the addition FB100 reduced foam substantially and resulted in a product that is much better suited to be a coating.

### Example 3

6 g of Tomah E-17-5 (poly (2) oxyethylene isotridecyloxypropylamine) was added to 10 g of Bayer Mondur N3200 (pre-poly of hexamethylene diisocyanate) and 0.5 g FB100 butyrate antifoam. The resulting tack free solid showed typical polymeric properties as it reacted. During the reaction, a highly fiberous and ordered plastic could be pulled from the vessel. The product reacted much slower than EXAMPLE 2 and foamed much less. This product was suitable as a coating or cast product.

### Example 4

4.3 g Tomah Q-17-5PG (74% active isotridecyloxypropyl poly (5) oxyethylene in propylene Glycol) were added to 10 g of Bayer Mondur E 744 (pre-poly of diphenylmethane 4,4′-diisocyanate). This reaction occurred very slowly with very little visible foaming. The material did form a translucent tack free solid after eight hours.

### Example 5

5.5 g of Crison Crisamine PC-2 (poly (2) oxyethylene primary cocoamine) was added to 10 g of Bayer Mondur E744 (pre-poly of diphenylmethane 4,4′-diisocyanate). The resulting tack free solid showed typical polymeric properties as it reacted. During the reaction, a highly fiberous and ordered plastic could be pulled from the vessel. The product liberated heat and foamed during the reaction but the addition of FB100 butyric antifoam helped reduce this. This material was optically clear. A slight reduction in Bayer Mindur E744 yielded a very soft flexible tack free material.

### Example 6

7 g of Crison Crisamine DC (cocodiamine)dissoloved in 40 g of a 50:50 mixture of naptha and acetone was added to 10 g of Bayer Mondur N3200 (pre-poly of hexamethylene diisocyanate). The products reacted very quickly, even with the solvent present and the aliphatic isocyanate. A tack free rubbery solid formed.

### Example 7

7 g Tomah Tomahdol 1-3 (poly (3) oxyethylene C₁₁ alcohol) were added to 10 g of Bayer Mondur E 744 (pre-poly of diphenylmethane 4,4′-diisocyanate). This reaction produced an optically clear, tack free plastic.

### Example 8

52 g Polyoxyethylene (15) tall oil acid was added to 10 g of Bayer Mondur N3200 (pre-poly of hexamethylene diisocyanate). This material foamed a lot and increased in volume by a factor of two. The resulting material was a very flexible closed cell foam plug.

### Example 9

12 g of Tomah DA-17 (Isotridecyloxypropyl-1,3-diaminopropane)was added 10 g to Bayer Mondur N3200 (pre-poly of hexamethylene diisocyanate) in 40 g of naptha. The reaction was almost instantaneous, white strands formed immediately upon contact and a tack free stringy mass resulted after the solvent was evaporated.

I claim:

1. A polymer, copolymer or prepolymer containing a fatty group pendant to the polymer backbone of the formula: 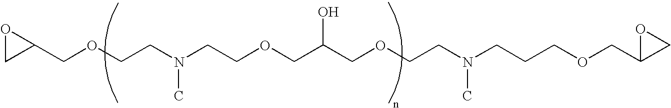
Where C is a saturated or unsaturated, branched or linear, alkyl group with between about 6 and 22 carbons

2. A surface coating comprising a polymer, copolymer or prepolymer according to claim 1.

3. A cast part comprising a polymer, copolymer or prepolymer according to claim 1.

4. An extruded film or fiber comprising a polymer, copolymer or prepolymer according to claim 1.

5. A polymer, copolymer or prepolymer according to claim 1 that is cross linked with an amine or polyamine.

6. A polymer, copolymer or prepolymer according to claim 1 that is crossed linked with a polyamine with a pendant fatty moiety according to the following structure: 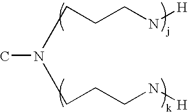
Where j is an integer from 1 to 50 and k is an integer from 0 to 50.

7. A polymer, copolymer or prepolymer according to claim 1 that is crossed linked with a polyamine with a pendant fatty moiety according to the following structure: 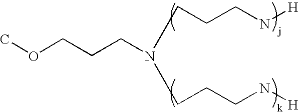
Where j is an integer from 1 to 50 and k is an integer from 0 to 50.

8. A polymer, copolymer or prepolymer containing a fatty group pendant to the polymer backbone of the formula: 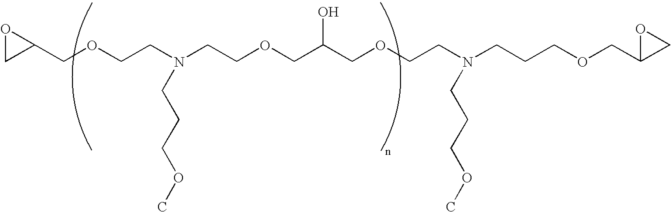
Where C is a saturated or unsaturated, linear or branched, alkyl group with between about 6 and 22 carbons

9. A surface coating comprising a polymer, copolymer, or prepolymer of claim 8.

10. A cast part comprised of a polymer, copolymer, or prepolymer of claim 8.

11. An extruded film or fiber comprised of a polymer, copolymer, or prepolymer of claim 8.

12. A polymer, copolymer, or prepolymer of claim 8 that is cross linked with an amine or polyamine.

13. A polymer, copolymer, or prepolymer of claim 8 that is crossed linked with a polyamine with a pendant fatty moiety according to the following structure: 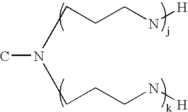
Where j is an integer from 1 to 50 and k is an integer from 0 to 50.

14. A polymer, copolymer, or prepolymer of claim 8 that is crossed linked with a polyamine with a pendant fatty moiety according to the following structure: 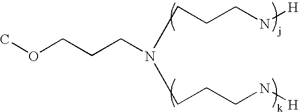
Where j is an integer from 1 to 50 and k is an integer from 0 to 50.

15. A polymer, copolymer, or prepolymer of claim 8 wherein C is a branched 10 carbon alkyl group.

16. A polymer, copolymer, or prepolymer of claim 8 wherein C is a branched 12 carbon alkyl group.

17. A polymer, copolymer, or prepolymer of claim 8 wherein C is a branched 13 carbon alkyl group.

18. A polymer, copolymer, or prepolymer of claim 8 wherein C is a branched 15 carbon alkyl group.

19. A polymer, copolymer or prepolymer containing a fatty group pendant to the polymer backbone of the formula: 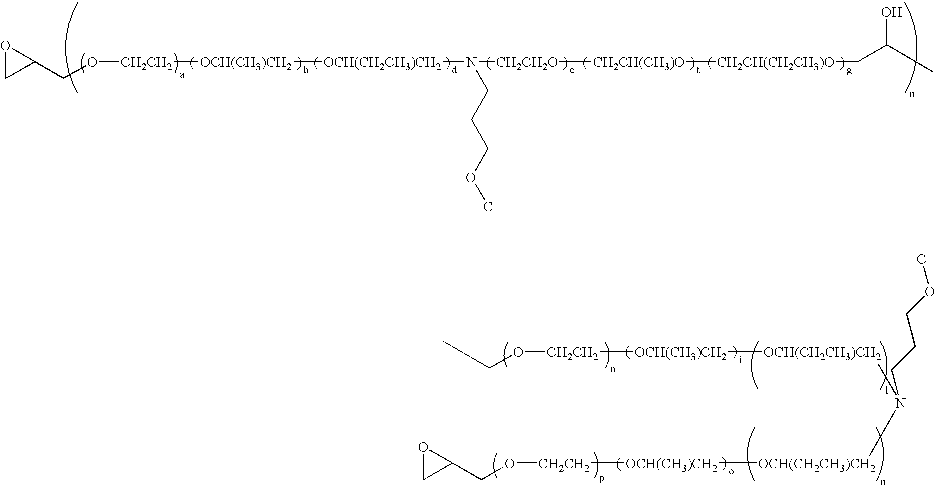
Where C is a saturated or unsaturated, linear or branched, alkyl group with between about 6 and 22 carbons and where a,b,d,e,f,g,h,i,l,m,n,o, and p are independently chosen integers from 0 to 100, however, a+b+d must be greater than zero, e+f+g must be greater than zero, h+i+l must be greater than zero, m+o+p must be greater than zero.

20. A surface coating comprising a polymer, copolymer or prepolymer according to claim 19.

21. A cast part comprising a polymer, copolymer or prepolymer according to claim 19.

22. An extruded film or fiber comprising a polymer, copolymer or prepolymer according to claim 19.

23. A polymer, copolymer or prepolymer according to claim 19 that is cross linked with an amine or polyamine.

24. A polymer, copolymer or prepolymer according to claim 19 that is crossed linked with a polyamine with a pendant fatty moiety according to the following structure: 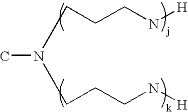
Where j is an integer from 1 to 50 and k is an integer from 0 to 50.

25. A polymer, copolymer or prepolymer according to claim 19 that is crossed linked with a polyamine with a pendant fatty moiety according to the following structure: 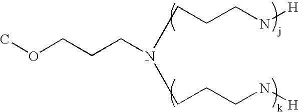
Where j is an integer from 1 to 50 and k is an integer from 0 to 50.
